(19) United States
(12) Patent Application Publication
(10) Pub. No.: US 2025/0143949 A1
(43) Pub. Date: May 8, 2025

(54) Spinal Decompression Treatment Modulation System

(71) Applicant: Excite Medical of Tampa Bay, LLC, Tampa, FL (US)

(72) Inventors: Scot Leslie Johnson, Tampa, FL (US); Saleem Najeeb Musallam, Lutz, FL (US)

(21) Appl. No.: 18/747,870

(22) Filed: Jun. 19, 2024

Related U.S. Application Data
(60) Provisional application No. 63/547,235, filed on Nov. 3, 2023.

(51) Int. Cl. A61H 1/02

(52) U.S. Cl. CPC A61H 1/0229; A61H 2201/0192

(57) ABSTRACT

A spinal decompression system operable to apply cyclical decompressive tension to a patient's spine over a range of treatment angles. The system accepts authorized user input to calculate a plurality of decompression tension cycles and the angles at which tension is applied throughout those cycles, forming one entire spinal decompression treatment profile. The system modulates the angle of the application of decompressive forces relative to a treatment platform during treatment in order to affect spinal elongation through one or more intervertebral disc locations during one single treatment session.

### FIELD OF THE DISCLOSURE

The present disclosure is directed generally to a spinal decompression system, and in particular to a modulation system for spinal decompression treatment.

### SUMMARY OF THE PRESENT DISCLOSURE

The present disclosure is directed to a modulation system for spinal decompression. Various embodiments of the disclosed modulation system may include the capability to continuously adjust the tension and treatment angle according to a variety of treatment profiles.

According to a first embodiment, the disclosure is directed to a system for applying a pre-calculated profile during spinal therapy. The system comprises a control system, a primary actuator, a secondary actuator, a patient interface device, a primary feedback system and a secondary feedback system. The control system is operable to implement a spinal treatment profile. The primary actuator is operable to produce a tensile force based on the implementation of a pre-calculated spinal treatment profile by the control system. The secondary actuator is operable to modulate the angle of application of a tensile force based on the implementation of the pre-calculated spinal treatment profile. The patient interface device is configured to communicate tensile force from the first actuator to the spine of a patient. The first feedback system is configured to provide metrics resulting from the application of the tensile force to the spine, to the control system. The secondary feedback system is configured to provide metrics resulting from the modulation of the angle of application of a tensile force to the spine, to the control system, such that the control system calculates elongation of the spine of the patient as a result of the tensile force and angle of application of the tensile force applied to the spine. The secondary feedback system also monitors the elongation relative to an intended elongation program of the pre-calculated treatment profile.

### BRIEF DESCRIPTION OF THE DRAWING FIGURES

The following brief descriptions reflect certain embodiments of the disclosure, but do not limit the embodiments enabled by the present disclosure:

FIG. 1 depicts a side elevation view of an apparatus for spinal decompression;

FIG. 2 depicts a cutaway side elevation view of the apparatus for spinal decompression shown in FIG. 1;

FIG. 3 depicts a side elevation view of the apparatus shown in FIG. 1 in an alternate configuration;

FIG. 4A is a chart showing prescribed tension over time;

FIG. 4B is a chart showing corrective tension over time;

FIG. 4C is a chart showing measured tension over time;

FIG. 5 is a chart showing prescribed tension and treatment at a constant angle over time;

FIG. 6 is a chart showing prescribed tension and treatment over time with an angular oscillation of 0.5 degrees;

FIG. 7 is a chart showing prescribed tension and treatment over time with an angular oscillation of 0.25 degrees;

FIG. 8 is a chart showing prescribed tension and treatment over time with fast transitions of the treatment angle;

FIG. 9 is a chart showing prescribed tension and treatment over time with step transitions of the treatment angle;

FIG. 10 is a chart showing prescribed tension and treatment over time with ramp transitions of the treatment angle;

FIG. 11 is a chart showing prescribed tension and treatment over time with log transitions of the treatment angle;

FIG. 12 is a chart showing prescribed tension and treatment over time with range transitions of the treatment angle;

FIG. 13A is a chart showing prescribed tension and treatment over time with log transitions of the treatment angle;

FIG. 13B is a chart showing corrective tension over time; and

FIG. 13C is a chart showing corrective tension over time.

The foregoing summary, as well as the following detailed description of certain embodiments of the present disclosure, will be better understood when read in conjunction with the appended drawing figures. For the purpose of illustrating the disclosure, certain embodiments are shown in the drawings. It should be understood, however, that the present disclosure is not limited to the arrangements and instrumentalities shown in the attached drawings.

### DETAILED DESCRIPTION OF THE DISCLOSURE

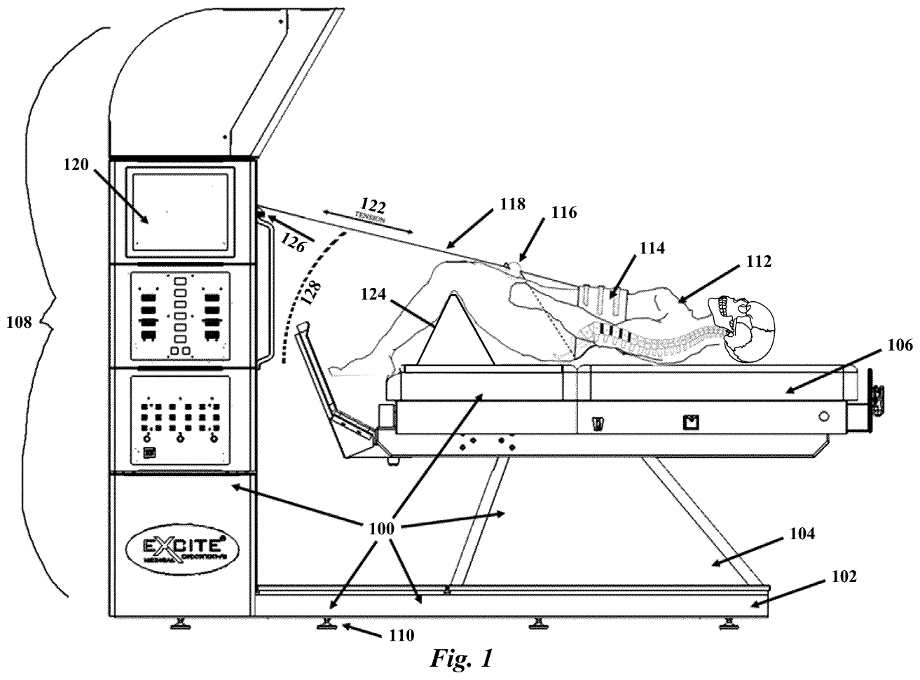

FIG. 1 illustrates one embodiment of the present disclosure. A spinal decompression therapy device 100 is shown, which consists of a base platform 102, a treatment pedestal 104, a treatment platform 106 (also referred to as a treatment bed), and a treatment tower 108. In one embodiment, the treatment bed 106 is parallel to the base platform 102. The base platform 102 is supported on adjustable-height support feet 110 which interface with a support surface, such as the floor in a medical clinic. Adjustable-height support feet 110 allow the leveling the base platform 102 so that it is parallel to the floor. The treatment tower 108 is perpendicular to the base platform 102.

Patient 112 is shown placed supine (lying flat, face looking up) upon the treatment bed 106. The patient's 112 skull and spine are shown within the patient's body. In certain embodiments, a knee bolster 124 is placed underneath the patient's 112 knees. A patient interface device 114 consists of a textile-harness, as has been described previously in U.S. non-provisional utility patent application Ser. No. 18/231,608 for “Pneumatic Pelvic Binder”. Suitable patient interface devices 114 include: Models E-PH-(XS, S, M, L, or XL) Pelvic Harness and Models E-UBH-(S, M, L, or XL) Upper Body Harness, sold by Excite Medical LLC of Tampa Bay and manufactured by US Orthotics Inc. (Tampa, FL). Patient interface device 114 contains straps which connect the interface device 114 to a tension ring 116.

A tension strap 118 is connected at one end to tension ring 116, and at the other end to a spool 202 mounted on the shaft of a rotational-electromechanical tension actuator 204 which resides within treatment tower 108. Suitable rotational-electromechanical tension actuators 204 consist of servo-amplifier+servo-motor combinations, or systems, in one preferred embodiment. Suitable servo-amplifiers include Model DPRANIE-015S400 (manufactured by Advanced Motion Controls) and Model CE03250 (manufactured by Kollmorgen). Suitable servo-motors include both AC SERVOMOTOR 1.115KW Model AKM44E-ANMN2-00 and AC SERVOMOTOR 0.93KW Model AKM41E-ANMN2-00 (manufactured by Kollmorgen). Tension actuator rotation is illustrated by dashed-line arrows 214. In one embodiment, tension actuator 204 is a feedback-providing device which communicates metrics including speed, acceleration, torque, work, distance, angular-travel, and electrical-power consumption to a treatment computer 120 which contains a touchscreen display. In one embodiment, the speed or rate of operation of tension actuator 204 is increased or decreased to produce resultant tension changes 122 at the point where tension strap 118 connects to tension ring 116. Changes in resultant tension 122 translate to the patient's 112 spine via patient interface device 114.

In certain embodiments of the present disclosure, the angle(s) 128 of applied tension 122 relative to a treatment platform 106 are plotted and displayed on a treatment computer 120 touchscreen display. In other embodiments, the angle(s) 128 of applied tension 122 are not displayed at all by treatment computer 120. It should be understood that displaying the angle 128 of applied tension 122 during treatment is not required to affect the disclosed advantages to a patient's 112 spinal decompression therapy session.

Tension strap 118 extends from tension ring 116 into the treatment tower 108 at a vertically-adjustable roller-cam block 126. Roller-cam block 126 allows tension strap 118 to move smoothly in and out of the tower, as resultant tension 122 is adjusted. The height of roller-cam block 126 relative to treatment bed 106 forms a treatment angle 128 relative to the treatment bed 106. Treatment angle 128 can range from a lower to an upper treatment angle 128 which allows for effective spinal decompression therapy. In one embodiment, treatment angle 128 can range from zero degrees to 36 degrees. In another embodiment, treatment angle 128 can range from zero degrees to 42 degrees. Spinal decompression system 100 is capable of modulating both applied tension 122 and the angle of applied tension 128 to the spine of patient 112 during the course of treatment.

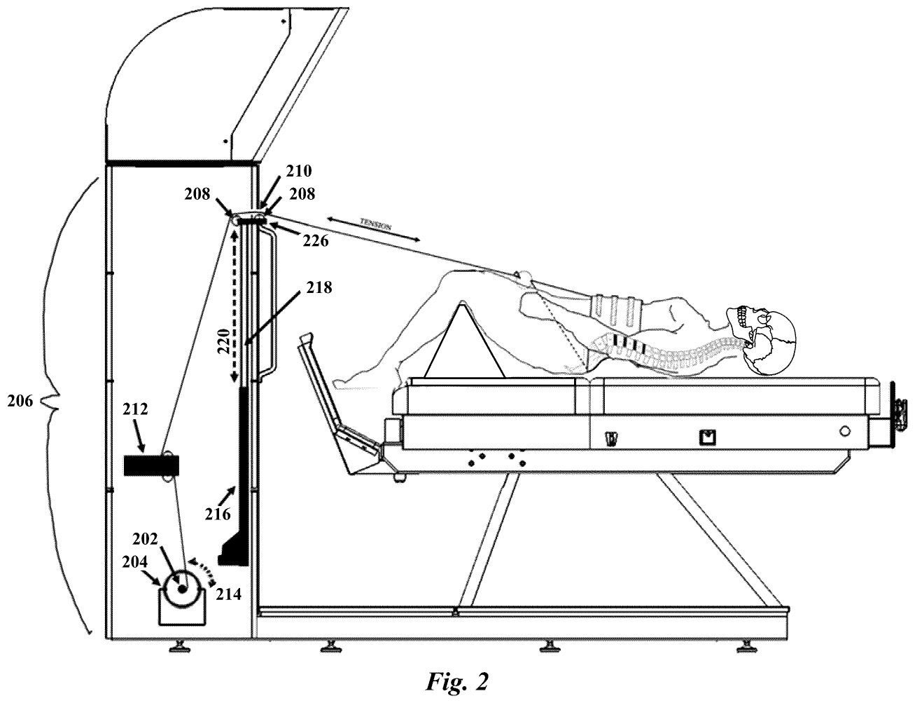

FIG. 2 shows the device 100 with a cut-away view 206 of tower 108, to illustrate the internal mechanisms therein. Tension strap 118 is shown traveling into tower 108 over roller-cam block 126/226. Roller-cam block 126/226 contains two roller-cams 208 over which tension strap 118 travels smoothly. In other embodiments, a suitably-sized and placed single roller-cam 208 is sufficient for tension strap 118 to travel over as it transits a vertical-slot 210 into tower 108 (slot 210 shown only as a gap in this view). In one embodiment, the roller-cam block 126 contains two roller cams 208, which are machined 6061-T6 aluminum cylinders. Each cylinder has a length of approximately one point seven inches, and a diameter of one and one-eighth inches. A cylindrical cavity runs centrally therethrough, with a diameter of approximately five-eighths of one inch. Into either end-face of the cylinder(s), a counter-bore is milled down approximately 0.340 inches and with a diameter of 0.8745 inches. Into each counterbore, at both ends of the cylinder(s), is pressed one radial ball bearing which accommodates a three-eighths inch diameter shoulder-bolt. Suitable radial ball bearings include TRITAN brand Model SSR6 2RS FM222, Radial Ball Bearing, R6, Dbl Sealed, Contact Seal, 3/8 in Bore, 7/8 in OD, 0.281 in Wd, 1. In one embodiment, the roller-cam block 126 supports each cylinder plus bearing assembly via mounting holes appropriate for a three-eighths inch diameter shoulder-bolt to secure therethrough.

Tension strap 118 travels over roller-cam block 126/226 and continues to a tension-measuring device 212. Tension-measuring device 212 utilizes a loadcell (not shown), in one embodiment of the present disclosure, to communicate tension metrics to a tension-producing actuator 204 controlling device which is a treatment computer 120. In another embodiment, tension-measuring device 212 utilizes a dynamometer. Suitable tension-measuring devices 212 include Group Four brand Models 3013-004-02 3013 Digital Load Cell and 8004-005-05 MBB Digital Load Cell, and Interface brand Models SM-500 Load Cell and MB-100 Load Cell. Through either or both of the feedback-providing tension actuator 204 and tension-measuring device 212, the system 100 operates as a controlled-feedback loop whereby a planned or ‘prescribed’ tension profile 404 can be applied to the patient 112 and the actual applied forces 122 can be verified by the computer 120.

Device 100 is used to perform decompression therapy 404 on the patient 112 by applying cycles of tensile forces 122/404 from the actuator 204 on the spine of the patient 112 through the interface device 114. Spinal decompression therapy involves both cyclical decompressive force 122/404 and specific alignment of the lumbar vertebra/intervertebral discs such that decompressive forces 122/404 applied pull ‘through’ and to the specific disc or discs of the patient 112 that are to be treated. For the purpose of this disclosure specification, this form of decompression will be referred to as ‘true decompression’. True decompression therapy provides the most advanced non-surgical form of unloading of compressive forces and healing of the intervertebral disc(s).

In one embodiment, an electromechanical linear actuator 216 is secured within the treatment tower 108. Suitable electromechanical linear actuators 216 include Linak brand Models LA31-U183 and LA31-U211. The body of linear actuator 216 contains a linear motor-shaft 218, controlled by the treatment computer 120, which linear actuator 216 extends and retracts as necessary. Linear motor-shaft 218 can extend and retract within a range 220. The body of linear-actuator 216 is fixed in place within treatment tower 108. The distal end of linear motor-shaft 218 is connected to roller-cam block 126/226, and is capable of vertically-displacing block 126/226 over a range 220. The non-moving body of linear actuator 216 is secured suitably low within tower 108 such that when linear motor-shaft 218 is fully-retracted, the top of roller-cam or roller-cams 208 is capable of achieving a zero-degree treatment angle 128.

In one embodiment, vertical displacement actuator 216 contains sensors which are capable of determining the amount of extension 220 of motor-shaft 218 and which communicate said extension amount 220 to a treatment computer 120 as a form of feedback. Such sensors are common and known to those with skill in the art. Such sensors may include, for example, magnetic reed switches which allow indirect empirical calculation of motor-shaft 218 extension by counting motor-screw rotations, as well as absolute and incremental encoders. For example, the Linak brand Model LA31's normal ordering options for monitoring shaft position include Reed Switches, Hall Positioning, and Hall Potentiometer. In alternate embodiments, inexpensive distance measuring devices including optical laser, ultrasonic, and infrared devices can be utilized to determine the vertical position of a roller-cam block 126/226. Suitable devices include Sparkfun brand Models SEN-16977 TFMini-S-Micro LiDAR Module (Light Detection and Ranging), HC-SR04 Ultrasonic Distance Sensor-3.3V, and GP2Y0A41SKOF Infrared Proximity Sensor Short Range-Sharp.

The vertical location of roller-cam block 126/226 within the slot 210 of treatment tower 108, over which the tension strap 118 smoothly travels, determines the treatment angle 128 at which tension 122 is applied to patient 112. In certain embodiments, actuator 216 is an electrically-powered actuator. In other embodiments, actuator 216 may utilize a pneumatic piston, hydraulic piston, or other type of actuator to move and place the roller-cam block 126/226. In certain embodiments, actuator 216 may be disposed above roller-cam block 126/226 and operate by pulling roller-cam block 126/226 upwards.

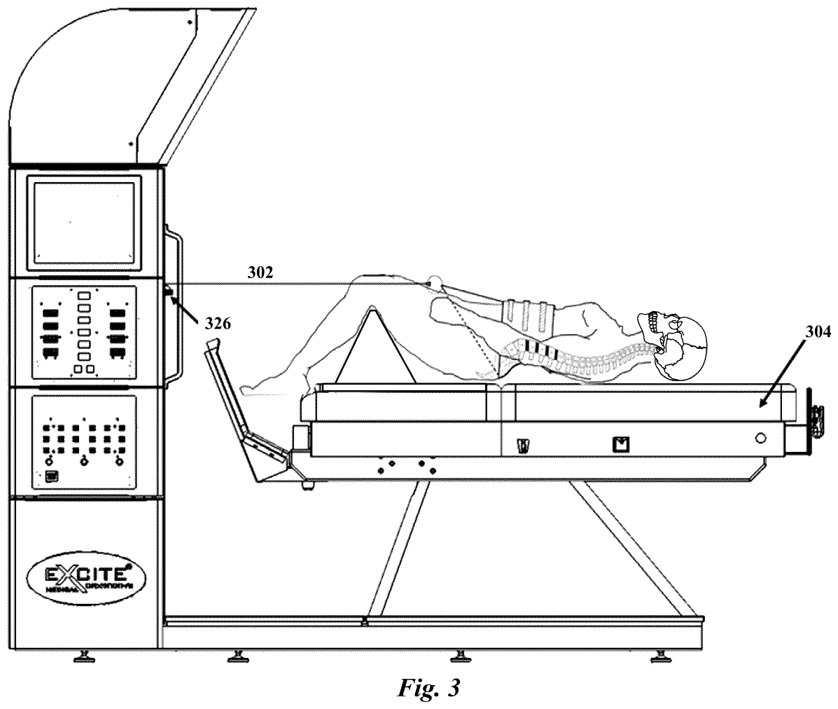

FIG. 3 shows device 100 in an alternate configuration from that shown in FIGS. 1 and 2. In this figure, roller-cam block 126/226/326 is positioned such that tension strap 118/302 is oriented parallel to the treatment bed 106/304. This configuration results in a treatment angle 128 of zero degrees.

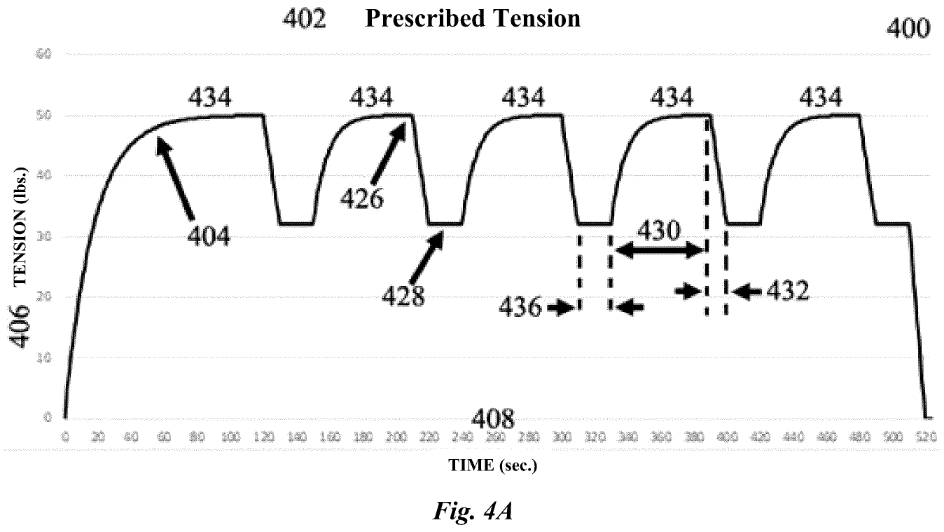

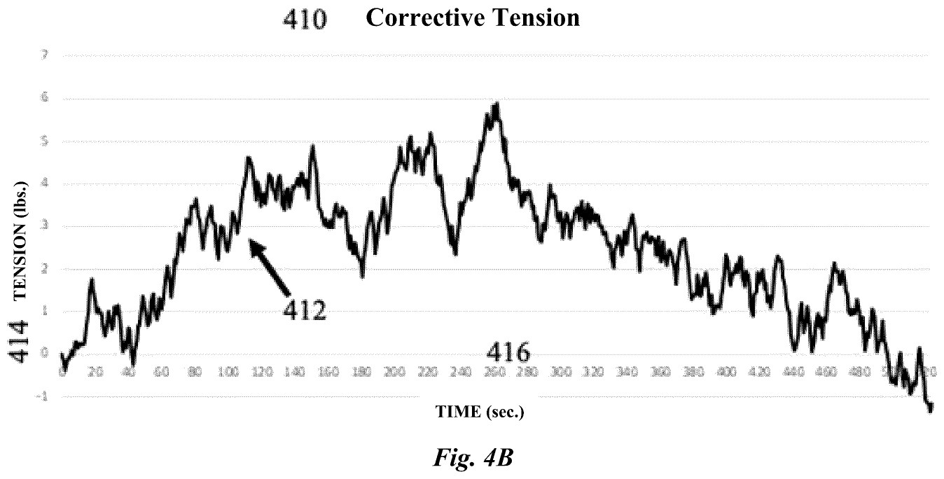

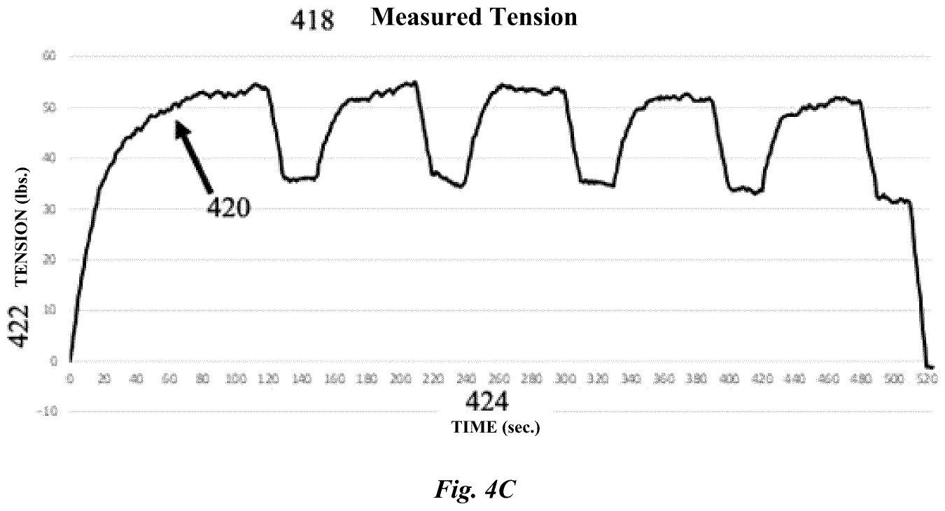

FIGS. 4A-4C illustrate a triple-plot summary 400 as may be displayed by a treatment computer 120 on its touchscreen display. In one embodiment, the triple-plot summary 400 is displayed on the touchscreen display of 120 and updates simultaneously during decompression treatment. The triple-plot summary consists of FIG. 4A centered within the top ⅓rd of the touchscreen display of 120, FIG. 4B centered within the middle ⅓rd of the touchscreen display of 120, and FIG. 4C centered within the bottom ⅓rd of the touchscreen display of 120 in one embodiment. FIG. 4A demonstrates one treatment session consisting of five decompressive tension cycles 434, formed according to pre-entered authorized user inputs. FIG. 4B is a record of the treatment computer's 120 corrections 412 to the applied tension 122 in order to approximate to the extent possible the predetermined spinal decompression treatment profile 402. FIG. 4C records the actual tension 420 measured throughout one complete treatment session 402.

The device 100 in one preferred embodiment of the present disclosure allows the healthcare provider or authorized user the ability, through a treatment computer 120 user interface, to input the treatment parameters that will be used by the computer's 120 microprocessor to calculate the full spinal decompressive force unloading curve 122/404 that will be applied to the patient's 112 spine. The parameters include, but are not limited to the following:
a) Maximum Spinal Decompressive Force (lbs.) 426
b) Minimum Spinal Decompressive Force (lbs.) 428
c) Maximum Tension Loading Time (seconds) 430
d) Minimum Tension Unloading Time (seconds) 432
e) Minimum Tension Plateau Time (seconds) 436
f) Number of Decompressive Cycles to be Applied (whole number>=1) 434

FIG. 4A illustrates the prescribed tension profile, as calculated by treatment computer 120. In one embodiment, treatment computer 120 which utilizes logarithmic increases in tension 404 up to a maximum load 426. The maximum tension loading time 430 of the first tension cycle 434 is typically extended for 1.5, 2, or 2.5 times the user-input maximum loading time 430 to allow the patient's 112 spine to accommodate to treatment at a slower rate. Plots 402/410/418 display applied tension on a vertical axis 406/414/422 in the appropriate tension units, and time on a horizontal axis 408.

From peak tension 426 at the end of the maximum tension loading time 430 of each decompressive cycle 434 (including the first prolonged cycle), begins the minimum tension unloading time 432. In one embodiment, tension 122 is reduced from peak tension 426 to minimum tension 428 over the minimum tension unloading time 432 in a linear ramp-down. Minimum tension is held for a period of time 436 in one embodiment of the present disclosure. As shown in plot 402, the authorized user has chosen to issue five decompressive cycles 434 for one complete treatment session.

Each decompressive cycle 434 consists of a loading phase 430 towards a maximum tension 426, a minimum unloading phase 432 towards a minimum tension 428, and a minimum tension phase 436 (sometimes referred to as a ‘minimum tension plateau’ 436).

FIG. 4B shows corrective tension, which is the amount of tension 412 added or subtracted from the currently measured tension 420 to approximate the prescribed tension 402 profile. Corrective tension 412 can accommodate multiple factors, including but not limited to:
a) dimensional changes in the structure of system 100
b) changes in patient 112 spinal length
c) dimensional changes in the structure of tension strap 118
d) dimensional changes in the structure of patient interface 114

Corrective tension 412 may be limited to a constant maximum and minimum value stored within the treatment computer, or may be set by an authorized user.

FIG. 4C displays the measured tension 420. Measured tension 420 is provided by either or both of the feedback-providing tension actuator 204 and tension-measuring device 212.

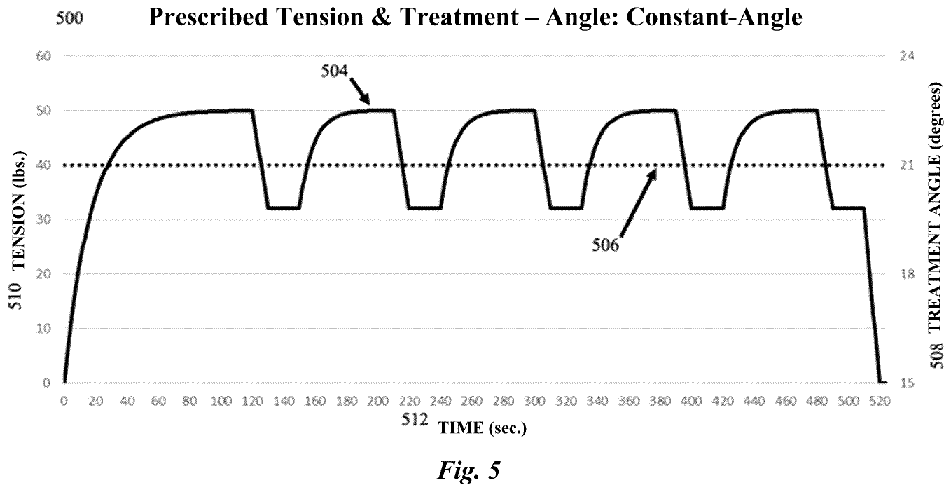

FIG. 5 depicts a combined plot 500 of a pre-calculated cyclical tension profile 504 referencing a primary y-axis 510, and a pre-calculated, constant treatment angle 506 which references a secondary y-axis 508 is shown. In one embodiment, combination plot 500 may replace plot 402 in a triple-plot summary displayed by a treatment computer 120 on its touchscreen display.

In FIG. 5, treatment angle 506 is shown as a dotted-line, and references secondary vertical axis 508. Plot 500 is the plot of 402, where prescribed tension profile 504 and prescribed treatment angle 506 are displayed on the same plot 500. Tension 122/504 references primary vertical axis 510. Both tension profile 504 and treatment angle 506 are plotted against time 512, and share a single horizontal axis 512. In one preferred embodiment, plot 500 would replace plot 402 in the triple-plot summary 400 as displayed on the treatment computer 120 touchscreen display. Plot 500 illustrates a constant treatment angle 506, which may be preset by an authorized user.

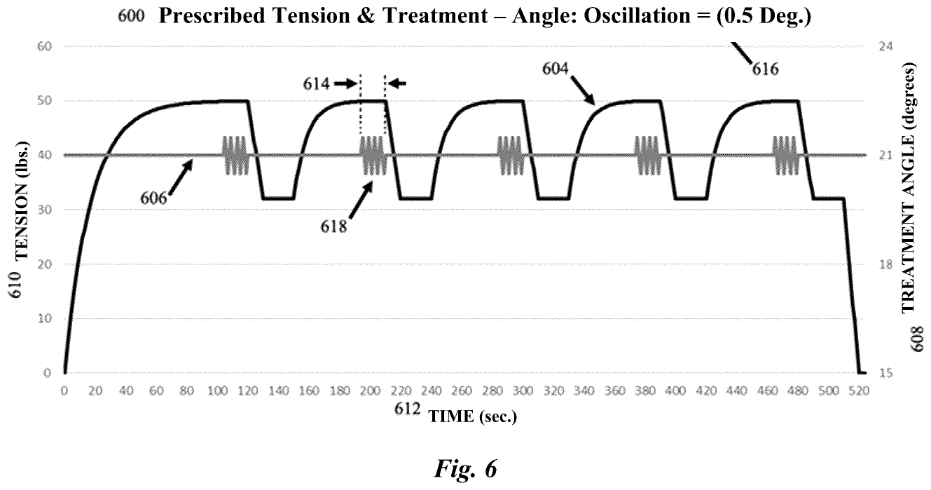

FIG. 6 depicts a combined plot 600 of a pre-calculated cyclical tension profile 604 referencing a primary y-axis 610, and a pre-calculated treatment angle profile 606 which references a secondary y-axis 608 is shown. Treatment angle profile 606 oscillates the angle 128 of applied tension 122 during certain portions of the tension profile 604. In one embodiment, combination plot 600 may replace plot 402 in a triple-plot summary displayed by a treatment computer 120 on its touchscreen display.

In FIG. 6, treatment angle 606 is shown as a lightly-shaded solid line, and references a secondary vertical axis 608. Plot 600 is the plot of 500, where prescribed tension profile 604 and prescribed treatment angle 606 are displayed on the same plot 600. Tension 122/604 references primary vertical axis 610. Both tension profile 604 and treatment angle 606 are plotted against time 612, and share a single horizontal axis 612. In one preferred embodiment, plot 600 would replace plot 402 in the triple-plot summary 400 as displayed on the treatment computer 120 touchscreen display.

Plot 600 illustrates a constant treatment angle 606 except during the final portion 614 of each maximum tension loading phase 430. In one embodiment, the duration of portions 614 may be entered as a treatment preset by an authorized user, and last for sixteen seconds. During the final parts 614 of each tension loading phase 430, the treatment angle 606 oscillates 618, increasing and decreasing by an amount 616 which may be entered by an authorized user as a treatment preset. In one embodiment, the treatment angle oscillation 618 follows a linear increasing and decreasing ramp (as shown). In other embodiments, treatment angle oscillation 618 may follow a series of discreet steps, a sinusoidal pattern, or a logarithmic pattern among other oscillatory mathematical functions.

Oscillating segments 618 may additionally facilitate intervertebral disc rehydration which is known to occur via diffusion gradients between intervertebral discs and adjoining bony vertebra segments. Oscillating segments 618 may increase paraspinal muscle confusion, which may reduce reflexive paraspinal muscle contraction. In one embodiment, oscillation 618 is reserved for the maximum tension plateaus 614 where the rate of change of tension 122 is lowest.

In another embodiment, the intensity of oscillation 616 varies throughout the progression of decompressive cycles 434 and may be preset by an authorized user. The intensity 616 of oscillations 618 may also vary according to specific decompressive cycles 434, and may also be preset by an authorized user. In other embodiments, oscillation 618 may occur at any points during decompressive cycles 434 or may occur throughout all decompressive cycles 434.

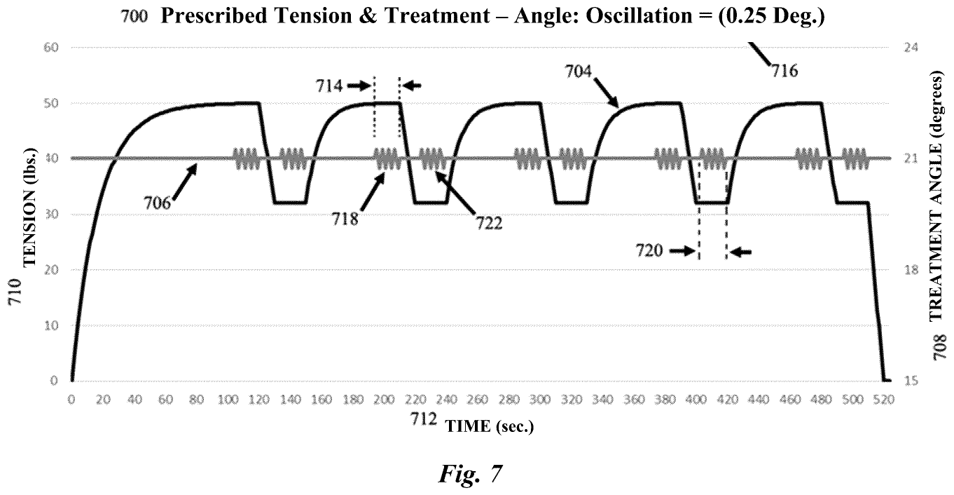

FIG. 7 depicts a combined plot 700 of a pre-calculated cyclical tension profile 704 referencing a primary y-axis 710, and a pre-calculated treatment angle profile 706 which references a secondary y-axis 708 is shown. Treatment angle profile 706 oscillates the angle 128 of applied tension 122 during certain portions of the tension profile 704. In one embodiment, combination plot 700 may replace plot 402 in a triple-plot summary displayed by a treatment computer 120 on its touchscreen display.

In FIG. 7, treatment angle 706 is shown as a lightly-shaded solid line, and references a secondary vertical axis 708. Plot 700 is the plot of 600, where prescribed tension profile 704 and prescribed treatment angle 706 are displayed on the same plot 700. Tension 122/704 references primary vertical axis 710. Both tension profile 704 and treatment angle 706 are plotted against time 712, and share a single horizontal axis 712. In one preferred embodiment, plot 700 would replace plot 402 in the triple-plot summary 400 as displayed on the treatment computer 120 touchscreen display.

Plot 700 illustrates a constant treatment angle 706 except during two parts of each decompressive cycle 434. A first portion 718 of each maximum tension loading phase 430 occurs near the end of loading phase 430, when changes in tension are relatively low. A second portion 722 occurs near the end of each minimum tension phase 432 where again changes in tension are relatively low. In one embodiment, portions 718 and 722 are sixteen seconds long 714/720, and their durations 714/720 may be entered as treatment presets by an authorized user.

In other embodiments, durations 714 and 720 are four seconds, eight seconds, or twelve seconds long. In other embodiments, durations 714 and 720 are the same amount of time. While in still further embodiments, the duration of portions 718 and 722 are different. In another embodiment, the duration of either or both portions 718 and 722 vary between different decompressive cycles 434.

During the final parts 714 of each tension loading phase 430, the treatment angle 706 oscillates 718, increasing and decreasing by an amount 716 which may be entered by an authorized user as a treatment preset. In one embodiment, the oscillation 718 follows a linear increasing and decreasing ramp. In other embodiments, oscillation 718 may follow a series of discreet steps, a sinusoidal pattern, or a logarithmic pattern among other oscillatory mathematical functions.

During the final parts 720 of each minimum tension phase 436, the treatment angle 706 oscillates 722, increasing and decreasing by an amount 716 which may be entered by an authorized user as a treatment preset. In one embodiment, the oscillation 720 follows a linear increasing and decreasing ramp. In other embodiments, treatment angle oscillation 720 may follow a series of discreet steps, a sinusoidal pattern, or a logarithmic pattern among other oscillatory mathematical functions.

The intensity 716 of oscillations 718 or 722 may also vary throughout the progression of decompressive cycles, and may also be preset by an authorized user. The intensity of oscillations 718 may be different than 722 in other embodiments. In another embodiment, the intensity of oscillation 716 varies throughout the progression of decompressive cycles 434 and may be preset by an authorized user. The intensity 716 of either or both oscillations 718 and 722 may also vary according to specific decompressive cycles 434, and may also be preset by an authorized user.

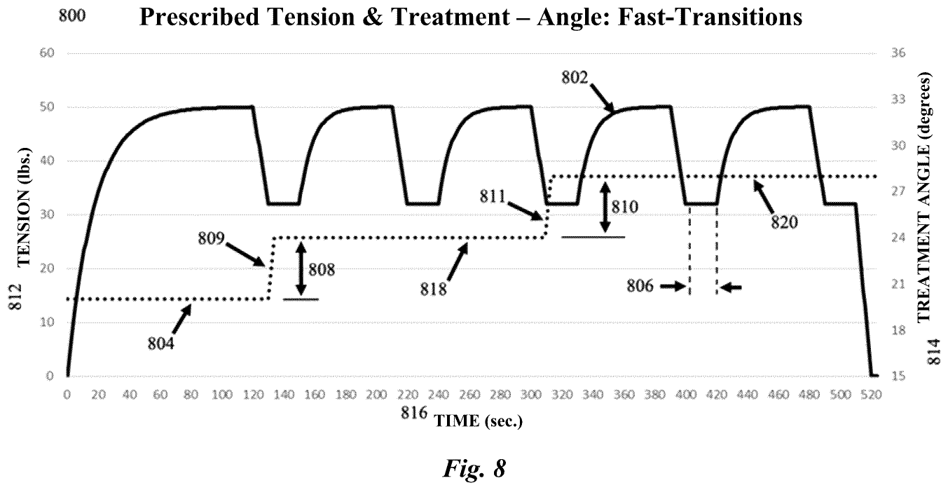

FIG. 8 depicts a combined plot 800 of a pre-calculated cyclical tension profile 802 referencing a primary y-axis 812, and a pre-calculated treatment angle profile 804 which references a secondary y-axis 814 is shown. Treatment angle profile 804 changes the angle 128 of applied tension 122 during certain portions of the tension profile 802. A method of modulating the angle 128 of applied tension 122 is disclosed, and is referred to herein as ‘fast-transitions’. In one embodiment, combination plot 800 may replace plot 402 in a triple-plot summary displayed by a treatment computer 120 on its touchscreen display.

In FIG. 8, treatment angle 804 is shown as a dotted line, and references a secondary vertical axis 814. Plot 800 is the plot of 500, where prescribed tension profile 802 and prescribed treatment angle 804 are displayed on the same plot 800. Tension 122/802 references primary vertical axis 812. Both tension profile 802 and treatment angle 804 are plotted against time 816, and share a single horizontal axis 816. In one preferred embodiment, plot 800 would replace plot 402 in the triple-plot summary 400 as displayed on the treatment computer 120 touchscreen display.

Plot 800 demonstrates two changes to treatment angle 804 during execution of decompressive tension profile 802. Plot 800 represents rapid, or ‘fast’ transitions 809/811 between otherwise constant treatment angle plateaus 804/818/820. Fast transitions 809/811 occur at the rate permissible by vertical-displacement actuator 216. As shown in plot 800, the transitions 809/811 occur at a rate of one degree per second in one embodiment of the disclosure. Transitions 809/811 represent increases of four degrees 808/810, in one embodiment of the present teachings.

Treatment angle 804 increases 809 at the beginning of the first minimum tension plateau 806, when changes in tension 802 are lowest and applied tension 122/802 is lowest. Treatment angle 818 increases 811 at the beginning of the third minimum tension plateau 806, when changes in tension 802 are lowest and applied tension 122/802 is lowest.

Transitions 809/811 may occur at any point, and may occur less or more frequently, and may change by amounts different than 808/810 during prescribed tension profile 802 in other embodiments of the present disclosure. Transitioning 809/811 angle 804/818/820 of applied tension 802 during prescribed tension profile 802 may allow for treating different portions of a patient's 112 spine sequentially throughout treatment. Changes in angle 804/818/820 may further facilitate intervertebral rehydration by the mechanisms previously stated, and may further reduce paraspinal muscle guarding as previously described. As shown, transitions 809/811 are linear ramp-ups from and to angle 804/818/820, however angle transitions may also be ramp-downs in other embodiments.

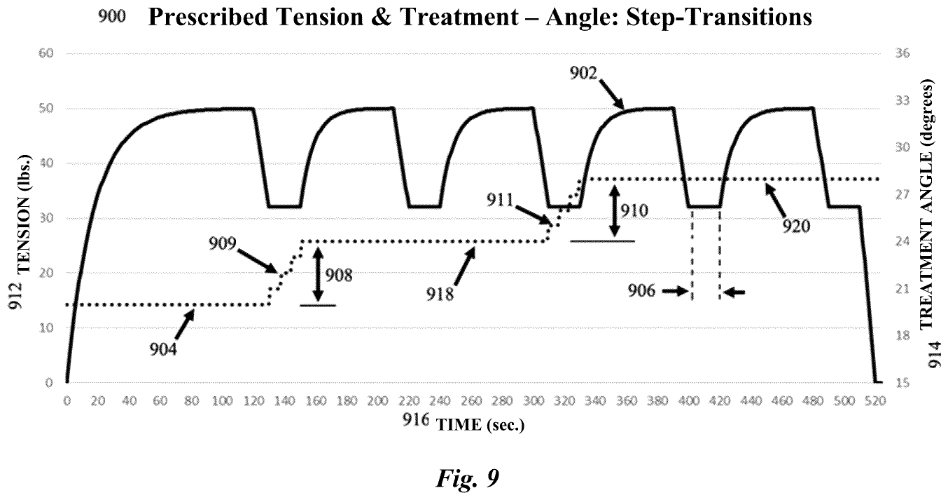

FIG. 9 depicts a combined plot 900 of a pre-calculated cyclical tension profile 902 referencing a primary y-axis 912, and a pre-calculated treatment angle profile 904 which references a secondary y-axis 914 is shown. Treatment angle profile 904 changes the angle 128 of applied tension 122 during certain portions of the tension profile 902. A method of modulating the angle 128 of applied tension 122 is disclosed, and is referred to herein as ‘step-transitions’. In one embodiment, combination plot 900 may replace plot 402 in a triple-plot summary displayed by a treatment computer 120 on its touchscreen display.

In FIG. 9, treatment angle 904 is shown as a dotted line, and references a secondary vertical axis 914. Plot 900 is the plot of 800, where prescribed tension profile 902 and prescribed treatment angle 904 are displayed on the same plot 900. Tension 122/902 references primary vertical axis 912. Both tension profile 902 and treatment angle 904 are plotted against time 916, and share a single horizontal axis 916. In one preferred embodiment, plot 900 would replace plot 402 in the triple-plot summary 400 as displayed on the treatment computer 120 touchscreen display.

Plot 900 demonstrates two changes to treatment angle 904 during execution of decompressive tension profile 902. Plot 900 represents rapid, or ‘fast’ transitions 909/911 between otherwise constant treatment angle plateaus 904/918/920. Fast transitions 909/911 occur at the rate permissible by vertical-displacement actuator 216. As shown in plot 900 and dissimilarly to the transitions 809/811, transitions 909 and 911 occur as a series of step-transitions, each step occurring at a rate of one degree per second in one embodiment of the disclosure. Following each single degree of angle change 908/910, angle 909/911 is held for a period of time, before increasing 908/910 again. A series of step-transitions 909/911 may allow for the patient's 112 spine to accommodate more gradually to changes in treatment angle. Transitions 909/911 represent increases of four degrees 908/910, in one embodiment of the present teachings.

Treatment angle 904 increases 909 at the beginning of the first minimum tension plateau 906, when changes in tension 902 are lowest and applied tension 122/902 is lowest. Treatment angle 918 increases 911 at the beginning of the third minimum tension plateau 906, when changes in tension 902 are lowest and applied tension 122/902 is lowest. Transitions 909/911 may occur at any point, and may occur less or more frequently, and may change by amounts different than 908/910 during prescribed tension profile 902 in other embodiments of the present disclosure.

Transitioning 909/911 angle 904/918/920 of applied tension 902 during prescribed tension profile 902 may allow for treating different portions of a patient's 112 spine sequentially throughout treatment. Changes in angle 904/918/920 may further facilitate intervertebral rehydration by the mechanisms previously stated, and may further reduce paraspinal muscle guarding as previously described. As shown, transitions 909/911 are step-wise linear ramp-ups from and to angle 904/918/920, however angle transitions may also be ramp-downs in other embodiments.

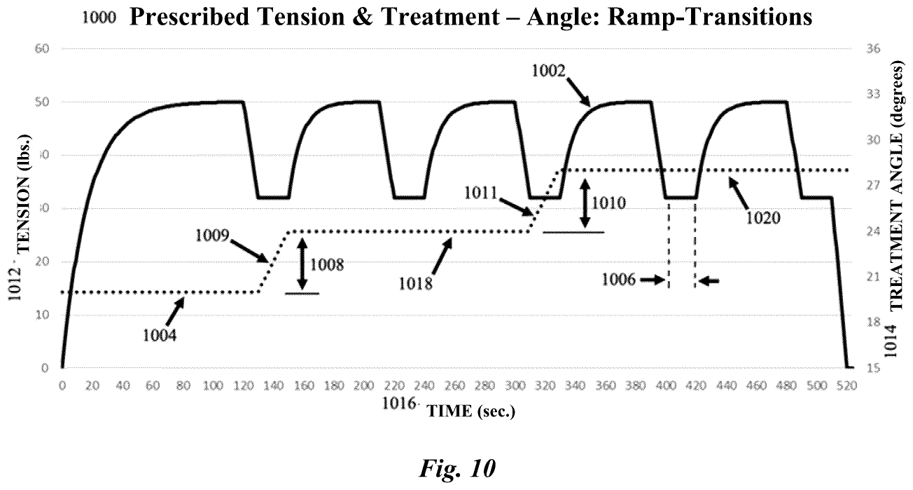

FIG. 10 depicts a combined plot 1000 of a pre-calculated cyclical tension profile 1002 referencing a primary y-axis 1012, and a pre-calculated treatment angle profile 1004 which references a secondary y-axis 1014 is shown. Treatment angle profile 1004 changes the angle 128 of applied tension 122 during certain portions of the tension profile 1002. A method of modulating the angle 128 of applied tension 122 is disclosed, and is referred to herein as ‘ramp-transitions’. In one embodiment, combination plot 1000 may replace plot 402 in a triple-plot summary displayed by a treatment computer 120 on its touchscreen display.

In FIG. 10, treatment angle 1004 is shown as a dotted line, and references a secondary vertical axis 1014. Plot 1000 is the plot of 900, where prescribed tension profile 1002 and prescribed treatment angle 1004 are displayed on the same plot 1000. Tension 122/1002 references primary vertical axis 1012. Both tension profile 1002 and treatment angle 1004 are plotted against time 1016, and share a single horizontal axis 1016. In one preferred embodiment, plot 1000 would replace plot 402 in the triple-plot summary 400 as displayed on the treatment computer 120 touchscreen display.

Plot 1000 demonstrates two changes to treatment angle 1004 during execution of decompressive tension profile 1002. Plot 1000 represents continuous linear transitions 1009/1011 between otherwise constant treatment angle plateaus 1004/1018/1020. Linear transitions 1009/1011 occur at a rate which may be input by an authorized user as a treatment parameter preset. Continuous, linear transitions 1009/1011 may allow for the patient's 112 spine to accommodate more gradually to changes in treatment angle. Transitions 1009/1011 represent increases of four degrees 1008/1010 which occur throughout the minimum tension plateaus 1006, in one embodiment of the present teachings. The duration of transitions 1009/1011 may be adjustable and may be treatment presets input by an authorized user into the treatment computer 120.

Treatment angle 1004 increases 1009 at the beginning of the first minimum tension plateau 1006, when changes in tension 1002 are lowest and applied tension 122/1002 is lowest. Treatment angle 1018 increases 1011 at the beginning of the third minimum tension plateau 1006, when changes in tension 1002 are lowest and applied tension 122/1002 is lowest. Transitions 1009/1011 may occur at any point, and may occur less or more frequently, and may change by amounts different than 1008/1010 during prescribed tension profile 1002 in other embodiments of the present disclosure.

Transitioning 1009/1011 angle 1004/1018/1020 of applied tension 1002 during prescribed tension profile 1002 may allow for treating different portions of a patient's 112 spine sequentially throughout treatment. Changes in angle 1004/1018/1020 may further facilitate intervertebral rehydration by the mechanisms previously stated, and may further reduce paraspinal muscle guarding as previously described. As shown, transitions 1009/1011 are continuous linear ramp-ups from and to angle 1004/1018/1020, however angle transitions may also be ramp-downs in other embodiments.

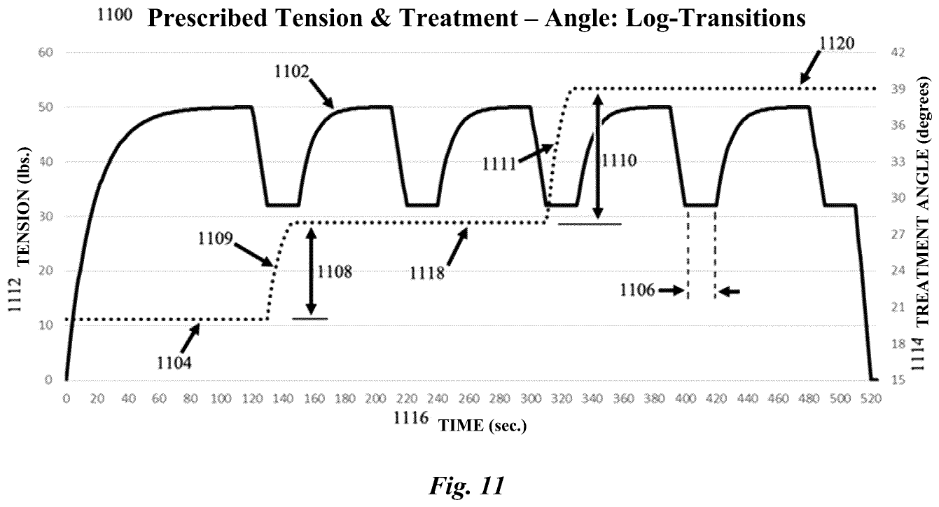

FIG. 11 depicts a combined plot 1100 of a pre-calculated cyclical tension profile 1102 referencing a primary y-axis 1112, and a pre-calculated treatment angle profile 1104 which references a secondary y-axis 1114 is shown. Treatment angle profile 1104 changes the angle 128 of applied tension 122 during certain portions of the tension profile 1102. A method of modulating the angle 128 of applied tension 122 is disclosed, and is referred to herein as ‘log-transitions’. In one embodiment, combination plot 1100 may replace plot 402 in a triple-plot summary displayed by a treatment computer 120 on its touchscreen display.

In FIG. 11, treatment angle 1104 is shown as a dotted line, and references a secondary vertical axis 1114. Plot 1100 is the plot of 1000, where prescribed tension profile 1102 and prescribed treatment angle 1104 are displayed on the same plot 1100. Tension 122/1102 references primary vertical axis 1112. Both tension profile 1102 and treatment angle 1104 are plotted against time 1116, and share a single horizontal axis 1116. In one preferred embodiment, plot 1100 would replace plot 402 in the triple-plot summary 400 as displayed on the treatment computer 120 touchscreen display, as is shown in Figure #13.

Plot 1100 demonstrates two changes to treatment angle 1104 during execution of decompressive tension profile 1102. Plot 1100 represents continuous increasing logarithmic transitions 1109/1111 between otherwise constant treatment angle plateaus 1104/1118/1120. Logarithmic transitions 1109/1111 occur at a rate which may be input by an authorized user as a treatment parameter preset. Continuous, logarithmic transitions 1109/1111 may allow for the patient's 112 spine to accommodate more gradually to changes in treatment angle. Transitions 1109/1111 represent different amounts of increase 1108/1110, respectively eight degrees and eleven degrees, occur throughout the duration of the minimum tension plateaus 1106, in one embodiment of the present teachings. The duration of transitions 1109/1111 may be adjustable and may be treatment presets input by an authorized user into the treatment computer 120.

Treatment angle 1104 increases 1109 at the beginning of the first minimum tension plateau 1106, when changes in tension 1102 are lowest and applied tension 122/1102 is lowest. Treatment angle 1118 increases 1111 at the beginning of the third minimum tension plateau 1106, when changes in tension 1102 are lowest and applied tension 122/1102 is lowest. Transitions 1109/1111 may occur at any point, and may occur less or more frequently, and may change by amounts different than 1108/1110 during prescribed tension profile 1102 in other embodiments of the present disclosure.

Transitioning 1109/1111 angle 1104/1118/1120 of applied tension 1102 during prescribed tension profile 1102 may allow for treating different portions of a patient's 112 spine sequentially throughout treatment. Changes in angle 1104/1118/1120 may further facilitate intervertebral rehydration by the mechanisms previously stated, and may further reduce paraspinal muscle guarding as previously described. As shown, transitions 1109/1111 are continuous logarithmic ramp-ups from and to angle 1104/1118/1120, however angle transitions may also be ramp-downs in other embodiments.

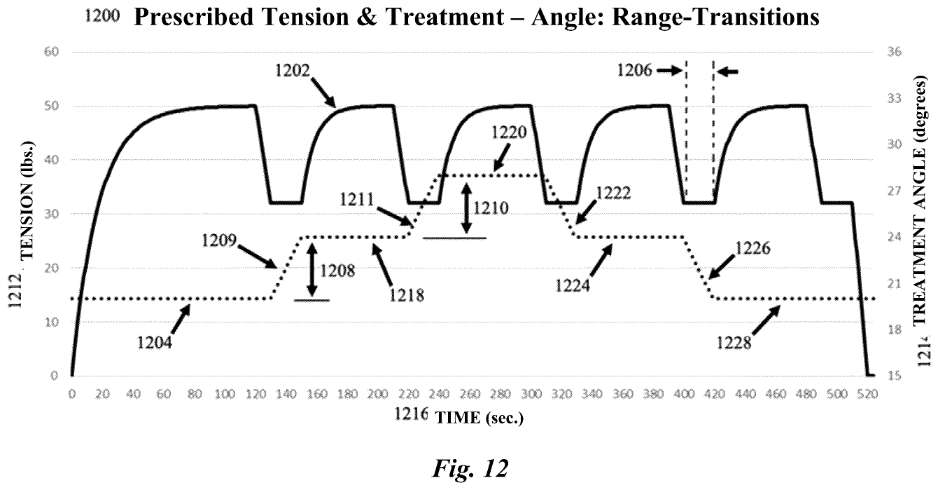

FIG. 12 depicts a combined plot 1200 of a pre-calculated cyclical tension profile 1202 referencing a primary y-axis 1212, and a pre-calculated treatment angle profile 1204 which references a secondary y-axis 1214 is shown. Treatment angle profile 1204 changes the angle 128 of applied tension 122 during certain portions of the tension profile 1202. A method of modulating the angle 128 of applied tension 122 is disclosed, and is referred to herein as ‘range-transitions’. In one embodiment, combination plot 1200 may replace plot 402 in a triple-plot summary displayed by a treatment computer 120 on its touchscreen display.

In FIG. 12, treatment angle 1204 is shown as a dotted line, and references a secondary vertical axis 1214. Plot 1200 is the plot of 1000, where prescribed tension profile 1202 and prescribed treatment angle 1204 are displayed on the same plot 1200. Tension 122/1202 references primary vertical axis 1212. Both tension profile 1202 and treatment angle 1204 are plotted against time 1216, and share a single horizontal axis 1216. In one preferred embodiment, plot 1200 would replace plot 402 in the triple-plot summary 400 as displayed on the treatment computer 120 touchscreen display.

Plot 1200 demonstrates two increasing changes to treatment angle 1204 during execution of decompressive tension profile 1202. Plot 1200 illustrates continuous increasing linear transitions 1209/1211 between otherwise constant treatment angle plateaus 1204/1218/1220. Linear transitions 1209/1211 occur at a rate which may be input by an authorized user as a treatment parameter preset. Continuous, increasing linear transitions 1209/1211 may allow for the patient's 112 spine to accommodate more gradually to changes in treatment angle. Transitions 1209/1211 represent increases of four degrees 1208/1210 which occur throughout the minimum tension plateaus 1206 following the first and second decompressive cycles' 434 minimum tension unloading phases 432, in one embodiment of the present teachings. The duration of transitions 1209/1211 may be adjustable and may be treatment presets input by an authorized user into the treatment computer 120.

Plot 1200 demonstrates two decreasing changes to treatment angle 1220 during execution of decompressive tension profile 1202. Plot 1200 illustrates continuous decreasing linear transitions 1222/1226 between otherwise constant treatment angle plateaus 1220/1224/1228. Linear transitions 1222/1226 occur at a rate which may be input by an authorized user as a treatment parameter preset. Continuous, decreasing linear transitions 1222/1226 may allow for the patient's 112 spine to accommodate more gradually to changes in treatment angle. Transitions 1222/1226 represent decreases of four degrees equivalent to 1208/1210 which occur throughout the minimum tension plateaus 1206 following the third and fourth decompressive cycles' 434 minimum tension unloading phases 432, in one embodiment of the present teachings. The duration of transitions 1222/1226 may be adjustable and may be treatment presets input by an authorized user into the treatment computer 120.

Plot 1200 demonstrates a series of linear transitions 1209/1211/1222/1226 which alter the initial plateau angle 1204 throughout a range of angles 1204/1218/1220/1224/1228 during the course of a prescribed tension profile 1202. For the purposes of the present application, this is referred to as “range-transitions”.

Treatment angle 1204 increases 1209 at the beginning of the first minimum tension plateau 1206, when changes in tension 1202 are lowest and applied tension 122/1202 is lowest. Treatment angle 1218 increases 1211 at the beginning of the second minimum tension plateau 1206, when changes in tension 1202 are lowest and applied tension 122/1202 is lowest. Treatment angle 1220 decreases 1222 at the beginning of the third minimum tension plateau 1206, when changes in tension 1202 are lowest and applied tension 122/1202 is lowest. Treatment angle 1224 decreases 1226 at the beginning of the fourth minimum tension plateau 1206, when changes in tension 1202 are lowest and applied tension 122/1202 is lowest.

Transitions 1209/1211/1222/1226 may occur at any point, and may occur less or more frequently, and may change by amounts different than 1208/1210 during prescribed tension profile 1202 in other embodiments of the present disclosure. Transitioning 1209/1211/1222/1226 angle 1204/1218/1220/1224/1228 of applied tension 1202 during prescribed tension profile 1202 may allow for treating different portions of a patient's 112 spine sequentially throughout treatment. Changes in angle 1204/1218/1220/1224/1228 may further facilitate intervertebral rehydration by the mechanisms previously stated, and may further reduce paraspinal muscle guarding as previously described.

As shown, transitions 1209/1211 are continuous increasing linear ramp-ups from and to angle 1204/1218/1220, and transitions 1222/1226 are continuous decreasing linear ramp-downs from and to angle 1220/1224/1228. However, angle transitions alternatively may be ramp-ups or ramp-downs in other embodiments. While plot 1200 demonstrates linear transitions 1209/1211/1222/1226 in angle, it should be understood by the teachings herein that transitions include the body of transitory-mathematical functions, including but not limited to fast-transitions, step-transitions, and log-transitions.

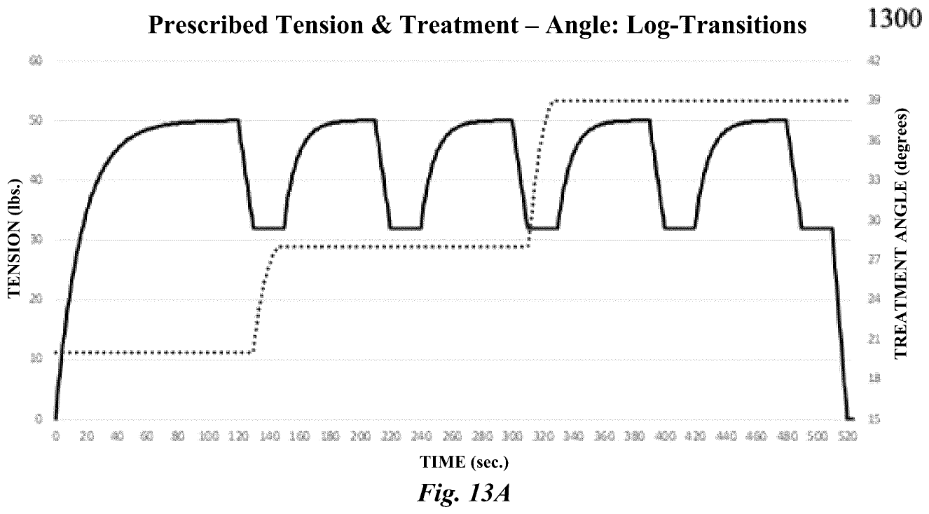

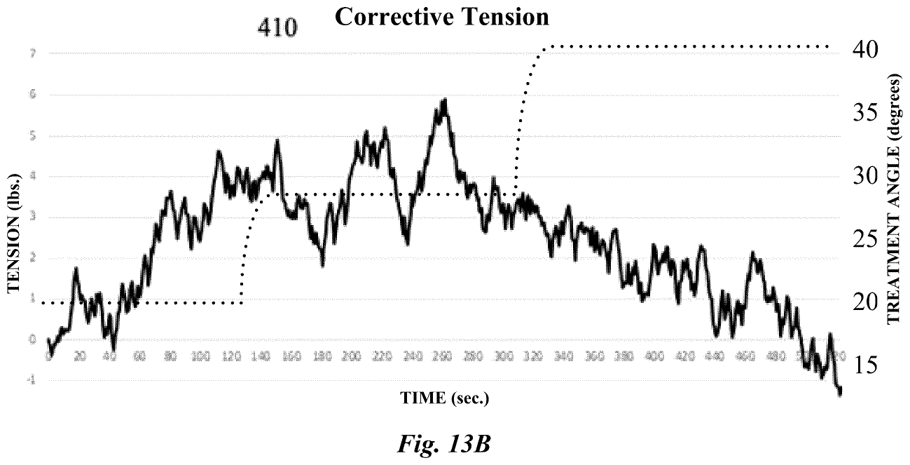

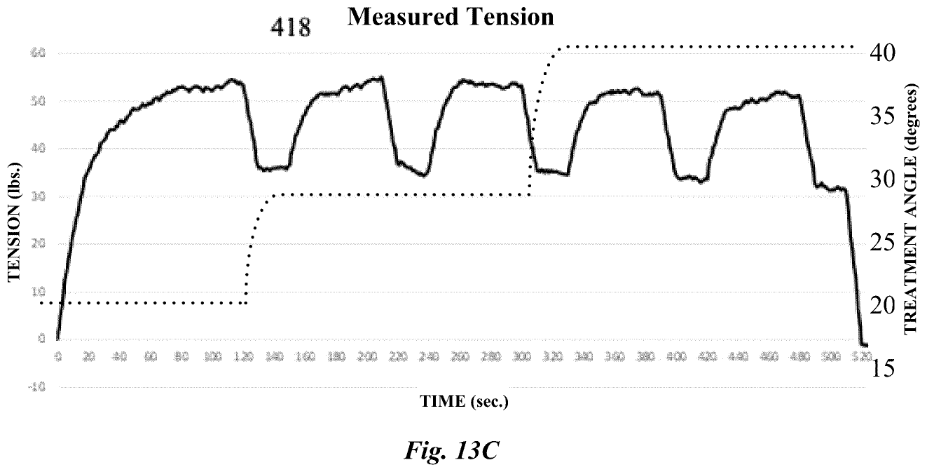

FIGS. 13A-13C illustrate a set of three graphs that may be displayed on the treatment computer 120 touchscreen display in a similar manner to FIGS. 4A-4C. FIG. 13A is a chart showing prescribed tension and treatment over time with log transitions of the treatment angle. FIG. 13B is a chart showing corrective tension over time. FIG. 13C is a chart showing measured tension over time.

As described above in connection with FIGS. 4A-4C, device 100 in one preferred embodiment of the present disclosure allows the healthcare provider or authorized user the ability, through a treatment computer 120 user interface, to input the treatment parameters that will be used by the microprocessor of computer 120 to calculate the full spinal decompressive force unloading curve that will be applied to the patient's spine.

FIG. 13A illustrates the prescribed tension profile, as calculated by treatment computer 120. In one embodiment, treatment computer 120 utilizes logarithmic increases in tension up to a maximum load in order to calculate and execute a pre-determined intended tension profile. The maximum tension loading time of the first tension cycle is typically extended for 1.5, 2, or 2.5 times the user-input maximum loading time to allow the patient's 112 spine to accommodate to treatment at a slower rate.

FIG. 13A shows a treatment profile comprising five decompressive cycles for one complete treatment session. From peak tension at the end of the maximum tension loading time of each decompressive cycle (including the first prolonged cycle), begins the minimum tension unloading time. In one embodiment, tension 122 is reduced from peak tension to minimum tension over the minimum tension unloading time in a linear ramp-down. Minimum tension is held for a period of time. Each decompressive cycle consists of a loading phase towards a maximum tension, a minimum unloading phase towards a minimum tension, and a minimum tension phase (sometimes referred to as a ‘minimum tension plateau’).

FIG. 13B is a plot of corrective tension over time. Corrective tension is the degree of tension added or subtracted by treatment computer 120 to the applied tension 122 in order to approximate to the extent possible the predetermined spinal decompression treatment profile. Corrective tension may be limited to a constant maximum and minimum value stored within the treatment computer, or may be set by an authorized user.

FIG. 13C records the actual tension measured throughout one complete treatment session. Measured tension is provided by either or both of the feedback-providing tension actuator and tension-measuring device.

While the foregoing disclosure has been described with reference to certain embodiments, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular embodiments disclosed, but that the disclosure will include all embodiments falling within the scope of the appended claims.

1. A system for applying a pre-calculated profile during spinal therapy, said system, comprising: a control system for implementing a spinal treatment profile;
a first actuator for producing a tensile force based on the implementation of a pre-calculated spinal treatment profile by said control system;
a secondary actuator for modulating the angle of application of a tensile force based on the implementation of said pre-calculated spinal treatment profile by said control system;
a patient interface device configured to communicate the tensile force from said first actuator to the spine of a patient;
a first feedback system configured to provide metrics resulting from the application of the tensile force to the spine, to said control system; and
a secondary feedback system configured to provide metrics resulting from the modulation of the angle of application of a tensile force to the spine, to said control system, such that said control system calculates elongation of the spine of the patient as a result of the tensile force and angle of application of the tensile force applied to the spine, and monitors the elongation relative to an intended elongation program of said pre-calculated treatment profile.
